(19) United States
(12) Patent Application Publication
(10) Pub. No.: US 2011/0139441 A1
(43) Pub. Date: Jun. 16, 2011

(54) SYSTEM, APPARATUS AND METHOD FOR STIMULATING WELLS AND MANAGING A NATURAL RESOURCE RESERVOIR

(75) Inventor: Alfredo ZOLEZZI GARRETON, Vina del Mar (CL)

(73) Assignee: TECHNOLOGICAL RESEARCH LTD., TORTOLA (VG)

(21) Appl. No.: 12/963,638

(22) Filed: Dec. 9, 2010

Related U.S. Application Data
(60) Provisional application No. 61/285,541, filed on Dec. 11, 2009.

(51) Int. Cl. E21B 43/00; E21B 47/18; G01V 1/00; E21B 28/00

(52) U.S. Cl. 166/249; 166/66; 367/83; 367/38; 166/177.1

(57) ABSTRACT

The invention provides a system, method and downhole tool for stimulating a borehole of wells in reservoir. The invention allows a user to determine the type of stimulation adequate to promote production in a reservoir, and apply one or more treatments to each individual well by activating one or more modules comprised in the downhole tools. Furthermore, the tool comprises sensors that collect information in real-time of the state of the reservoir. The data collected is processed and newly acquired data is compared with previously acquired data to assess the development of production and further plan treatment strategies to optimize production.

### FIELD OF THE INVENTION

The invention relates to stimulating and managing production of wells producing natural resources such as crude oil, gas, and/or water; in particular the invention relates to a system, method, and apparatus for stimulating a geologic formation using a downhole tool to apply high- and low-frequency mechanical waves in one or more wells in a production field, and a system for collecting information data of production parameters, and processing the data to guide the stimulation process.

A portion of the disclosure of this patent document contains material which is subject to copyright protection. The copyright owner has no objection to the facsimile reproduction by anyone of the patent document or the patent disclosure, as it appears in the Patent and Trademark Office file or records, but otherwise reserves all copyrights associated with this document.

### BACKGROUND OF THE INVENTION

A major challenge with production of natural resources such as oil, gas and water from wells is that the productivity gradually decreases over time. While a decrease is expected to naturally accompanies the depletion of the reserves in the reservoir, often well before any significant depletion of the reserves, production diminishes as a result of factors that affect the geologic formation in the zone immediately surrounding the well and in the well's configuration itself. For example, Crude Oil production can decrease as a result of the reduction in permeability of the rock formation surrounding the well, a decrease of the fluidity of oil or the deposit of solids in the perforations leading to the collection zone of the well.

In production wells, perforations aid the fluid from the formation seeping through cracks or fissures in the formation to flow toward a collection compartment in the well. Hence, the pore size of the perforations connecting the well to the formation determines the flow rate of the fluid from the formation toward the well. Along with the flow of oil, gas or water, very small solid particles from the formation, called “fines,” flow and often settle around and within the well, thus, reducing the pore size.

Solids such as clays, colloids, salts, paraffin etc. accumulate in perforation zones of the well. These solids reduce the absolute permeability, or interconnection between pores. Mineral particles may be deposited, inorganic scales may precipitate, paraffins, asphalt or bitumen may settle, clay may become hydrated, and solids from mud and brine from injections may invade the perforations. The latter problems lead to a flow restriction in the zone surrounding the perforations.

As a result of the reduction of productivity, of oil wells for example, the exploitation may become prohibitively expensive forcing abandonment of the wells.

Production wells of oil and gas, for instance, are periodically stimulated by applying three general types of treatment: mechanical, chemical, and other conventional techniques which include intensive rinsing, fracturing and acid treatment.

Chemical acid treatment consists of injecting in the production zone mixtures of acids, such as hydrochloric acid and hydrofluoric acid (HCl and HF). Acid is used for dissolving reactive components (e.g., carbonates, clay minerals, and in a smaller quantity, silicates) in the rock, thus increasing permeability. Additives, such as reaction retarding agents and solvents, are frequently added to the mixtures to improve acid performance in the acidizing operation.

While acid treatment is a common treatment to stimulate oil and gas wells, this treatment has multiple drawbacks. Among the drawbacks of acid treatment are: 1) the cost of acids and the cost of disposing of production wastes are high; 2) acids are often incompatible with crude oil, and may produce viscous oily residues inside the well; precipitates formed once the acid is consumed can often be more obnoxious than dissolved minerals; and 3) the penetration depth of active or live acid is generally low (less than 5 inches or 12.7 cm).

Hydraulic fracturing is a mechanical treatment usually used for stimulating oil and gas wells. In this process, high hydraulic pressures are used to produce vertical fractures in the formation. Fractures can be filled with polymer plugs, or treated with acid (in rocks, carbonates, and soft rocks), to form permeability channels inside the wellbore region; these channels allow oil and gas to flow. However, the cost of hydraulic fracturing is extremely high (as much as 5 to 10 times higher than acid treatment costs). In some cases, fracture may extend inside areas where water is present, thus increasing the quantity of water produced (a significant drawback for oil extraction). Hydraulic fracture treatments extend several hundred meters from the well, and are used more frequently when rocks are of low permeability. The possibility of forming successful polymer plugs in all fractures is usually limited, and problems such as plugging of fractures and grinding of the plug may severely deteriorate productivity of hydraulic fractures.

Another method for improving oil production in wells involves injecting steam or water. One of the most common problems in depleted oil wells is precipitation of paraffin and asphaltenes or bitumen inside and around the well. Steam of hot oil has been injected in these wells to melt and dissolve paraffin into the oil or petroleum, and then all the mixture flows to the surface. Frequently, organic solvents are used (such as xylene) to remove asphaltenes or bitumen whose melting point is high, and which are insoluble in alkanes. Steam and solvents are very costly (solvents more so than steam), particularly when marginal wells are treated, producing less than 10 oil barrels per day. The main limitation for use of steam and solvents is the absence of mechanical mixing, which is required for dissolving or maintaining paraffin, asphaltenes or bitumen in suspension.

Empirical evidence have shown that seismic type waves may have an important effect on oil reservoirs. For example, following seismic waves, either from earthquakes or artificial induction, there is a rise in the fluid levels (water or oil), yielding an increase in oil production. A report on these phenomena is published by I. A. Beresnev and P. A. Johnson (GEOPHYSICS, VOL. 59, NO. 6, JUNE 1994; P. 1000-1017), which is included in its entirety herewith by reference.

Several methods using sound waves to stimulate oil wells have been described. Challacombe (U.S. Pat. No. 3,721,297) describes a tool for cleaning wells using pressure pulses: a series of explosive and gas generator modules are interconnected in a chain, in such a manner that ignition of one of the explosives triggers the next one and a progression or sequence of explosions is produced. These explosions generate shock waves that clean the well. There are obvious disadvantages of this method, such as potential damages that can be caused to high-pressure oil and gas wells. Use of this method is not feasible because for additional dangers including fire and lack of control during treatment period.

Sawyer (U.S. Pat. No. 3,648,769) describes a hydraulically controlled diaphragm that produces “sinusoidal vibrations in the low acoustic range”. Generated waves are of low intensity, and are not directed or focused to face the formation (rock). As a consequence, the major part of energy is propagated along the perforations.

Ultrasound techniques have been developed to increase production of crude oil from wells. However, there is a great amount of effects associated with exposing solids and fluids to an ultrasound field of certain frequencies and energy. In the case of fluids in particular, cavitation bubbles can be generated. These are bubbles of gas dissolved in liquid, or bubbles of the gaseous state of the same liquid (change of phase). Other associated phenomena are liquid degassing and cleaning of solid surfaces.

Maki Jr. et al. (U.S. Pat. No. 5,595,243) propose an acoustic device in which a piezoceramic transducer is set as radiator. The device presents difficulties in its manufacturing and use, because an asynchronous operation is required of a high number of piezoceramic radiators.

Vladimir Abramov et al., in “Device for Transferring Ultrasonic Energy to a Liquid or Pasty Medium” (U.S. Pat. No. 5,994,818) and in “Device for Transmitting Ultrasonic Energy to a Liquid or Pasty Medium” (U.S. Pat. No. 6,429,575), propose an apparatus consisting of an alternating current generator operating within the range of 1 to 100 kHz to transmit ultrasonic energy, and a piezoceramic or magnetostrictive transducer emitting ultrasound waves, which are transformed by a tubular resonator or wave guide system (or sonotrode) in transverse oscillations that contact the irradiated liquid or pasty medium. However, these patents are conceived to be used in containers of very large dimensions, at least as compared with the size and geometry of perforations present in wells. This shows limitations from a dimensional point of view, and also for transmission mode if it is desired to enhance production capacities of oil wells.

Julie C. Slaughter et al., in “Ultrasound Radiator of Downhole Type and Method for Using It” (In U.S. Pat. No. 6,230,788), propose a device that uses ultrasonic transducers manufactured of Terfenol-D alloy and placed at the well bottom, and fed by an ultrasonic generator located at the surface. Location of transducers, axially to the device, allows the emission along a transverse direction. This invention proposes a viscosity reduction of hydrocarbons contained in the well through emulsification, when reacting with an alkaline solution injected to the well. This device considers a forced shallow circulation of fluid as a refrigeration system, to warrant continuity of irradiation.

Dennos C. Wegener et al., in “Heavy Oil Viscosity Reduction and Production,” (U.S. Pat. No. 6,279,653), describe a method and a device for producing heavy oil (API specific gravity less than 20) applying ultrasound generated by a transducer made of Terfenol alloy, attached to a conventional extraction pump, and powered by a generator installed at the surface. In this invention the presence of an alkaline solution is also considered, similar to an aqueous sodium hydroxide (NaOH) solution, to generate an emulsion with crude oil of lower density and viscosity, thereby facilitating recovery of the crude by impulsion with a pump. Here, a transducer is installed in an axial position to produce longitudinal ultrasound emissions. The transducer is connected to an adjacent rod that operates as a wave guide or sonotrode.

Robert J. Meyer et al., in “Method for improving Oil Recovery Using an Ultrasonic Technique” (U.S. Pat. No. 6,405,796), propose a method to recover oil using an ultrasound technique. The proposed method consists of disintegrating agglomerates by means of an ultrasonic irradiation technique, and the operation is proposed within a certain frequency range, for the purpose of handling fluids and solids in different conditions. Main oil recovery mechanism is based in the relative momentum of these components within the device.

The latter mentioned prior art generates ultrasonic waves via a transducer that is externally supplied by an electric generator connected to the transducer through a transmission cable. The transmission cable is generally longer than 2 km, which has the disadvantage of signal transmission loss. Since high-frequency electric current transmission to such depths is reduced to 10% of its initial value, the generated signal must have a high intensity (or energy), enough for an adequate operation of the transducers within the well. Furthermore, since the transducers need to operate at a high-power regime, water or air cooling system is required, which in turn poses great difficulties when placed inside the well. The latter implies that ultrasound intensity must not exceed 0.5-0.6 W/cm2. This level is insufficient for the desired purposes, because threshold of acoustic effects in oil and rocks is from 0.8 to 1 W/cm2.

Andrey a. Pechkov, in “Method for Acoustic Stimulation of Wellbore Bottom Zone for Production Formation” (RU Patent No. 2 026 969), disclose methods and devices for stimulating production of fluids within a producing well. These devices incorporate, as an innovating element, an electric generator attached to the transducer, and both of them integrated in the well bottom. These transducers operate in a non-continuous mode, and can operate without needing an external cooling system. The impossibility of operating in a continuous mode to prevent overheating is one of the main drawbacks of this implementation since the availability of the device is reduced. Moreover, because the generator is located in the wellbottom, and especially because of the use of high power, the failure rate of the equipment is likely to be high, thus raising the cost of maintenance.

Oleg Abramov et al., in “Acoustic Method for Recovery of Wells, and Apparatus for its Implementation” (U.S. Pat. No. 7,063,144), disclosure an electro-acoustic method for stimulation of production within an oil well. The method consists of stimulating, by powerful ultrasound waves, the well extraction zone, causing an increase of mass transfer through its walls. This ultrasonic field produces large tension and pressure waves in the formation, thus facilitating the passage of liquids through well recovery orifices. It also prevents accumulation of “fines” on these holes, thereby increasing the life of the well and its extraction capacity.

Kostyuchenko in “Method and apparatus for generating seismic waves” (U.S. Pat. No. 6,776,256) generates seismic waves in an oil reservoir for well stimulation by chemical detonation. A packer is lowered into the well, where a fuel and air mixture is injected, and then detonated, generating seismic waves that reach the well walls. Some problems may appear considering possible unwanted explosions and difficulties regarding the transportation of a fuel and air mixture deep into the well.

Kostrov in “Method and apparatus for seismic stimulation of fluid bearing formations” (U.S. Pat. No. 6,899,175) describe another device for seismic waves generation. Shock waves are generated when compressed liquid is discharged to the well casing, forming seismic waves in the well borehole. This device has a limited range of applications as it may be only used in injection wells.

Ellingsen in “Sound source for stimulation of oil reservoirs” (US patent application publication 2009/0008082) a seismic wave generator is presented. Pressurized gas from a compressor located on the surface is transported into the wellbore where it operates a sound source that emits the seismic waves. The main limitation of this device is that it cannot operate over 1 kHz.

Murray in “Electric pressure actuating tool and method” (U.S. Pat. No. 7,367,405) describes using a tool to stimulate a down-hole using mechanical waves. This tool comprises a housing having a chamber filled with liquid, where an electrical discharge is produced. The discharge vaporizes the liquid creating a shock wave that pushes a piston, thus generating a pressure wave in the surrounding fluid. However, the presence of moving parts in the down hole may present difficulties, for instance, to provide required maintenance.

In “The application of high-power sound waves for wellbore cleaning”, Champion et al., analyze techniques related to high power sound waves used in well stimulation, and indicate that a variety of techniques exists for the generation of sound waves, with one of the most common laboratory methods comprising the use of either piezoelectric or magnetostrictive type transducers. The piezoelectric devices employ a crystal that oscillates in response to an applied oscillating voltage, while the magnetostrictive devices employ an alloy that changes shape in the presence of a magnetic field and, creates a powerful force. In both cases, this study indicates that, the oscillatory movement generated is used to drive an acoustic transmitter element. The average power level of these devices is in the region of 0.5 watts/cm2, and the potential to increase this significantly is limited because of the presence of gas bubbles released by the periodic pressure oscillations within the fluid. Instead of this method based on transducers Champion et al. proposes the generation of high power sound waves by initiating a high voltage electrical discharge in a liquid medium—the electrolyte. This concept of sound wave generation has been practiced previously in the development and application of marine and downhole seismic “sparker” sources.

A high-energy electrical discharge, which may be of the order or several hundred joules, is triggered at a spark gap submerged in an electrolyte. Typical electrical-breakdown times in water can be engineered to occur in the nanosecond time scale. A high current flows from the anode to cathode, which causes the electrolyte adjacent to the spark gap to vaporize and form a rapidly expanding plasma gas bubble. After the discharge stops, the bubble continues to expand until its diameter increases beyond the limit sustainable by surface tension, at which point it will rapidly collapse (cavitation mechanism), producing the shock wave that propagates through the fluid and is used for wellbore cleaning. Previous work in the field has demonstrated that the creation of this transient acoustic shock wave, in the form of a pressure step function, has the potential to generate high power ultrasound with an intensity of greater than 50 watt/cm².

Sidney Fisher and Charles Fisher in “Recovery of hydrocarbons from partially exhausted oil wells by mechanical wave heating” (U.S. Pat. No. 4,049,053) describe heating underground viscous hydrocarbon deposits, such as the viscous residues in conventional oil wells, by mechanical wave energy to fluidize the hydrocarbons thereby to facilitate extraction thereof. The latter invention comprises a system for generating mechanical waves located on the ground surface transmitting the waves to the bottom of the well.

U.S. Pat. No. 7,079,952, entitled “System and Method for Real Time Reservoir Management” to Halliburton Energy Services, Inc. This patent comprises a field wide management system for a petroleum reservoir on a real time basis. This field management system comprises a several software tools that seamlessly interface with each other to generate a field production and injection forecast. The resultant output of the system disclosed in this patent is a real time control of downhole production and/or injection flow devices such as chokes, valves and other control devices and real time control of surface production and injection control devices.

U.S. Pat. No. 6,943,697, “Reservoir Management System and Method” to Schlumberger Technology Corporation. The latter discloses a system for controlling depletion rates of a hydrocarbon field being developed is described. In this system the central control unit receives formation data and analyzes the formation data for a plurality of Wells in order to determine the depletion rate for each well so that the field may be depleted in an economic and efficient manner.

Patent Application US 2007/0156377, Integrated Reservoir Optimization. The latter patent discloses a method for managing a fluid or gas reservoir. This system assimilates diverse data having different acquisition time scales (frequent and infrequent or high and low rate respectively) producing a reservoir deployment plan that is used for optimizing an overall performance of the reservoir.

U.S. Pat. No. 7,809,537 B2, entitled “Generalized Well Management in Parallel Reservoir Simulation” discloses a computer implemented method of analyzing performance of a hydrocarbon reservoir for prediction of future production of hydrocarbon fluids from Wells in the reservoir. A set of production rules is established for an object in the formation. An object may be a well, a number of completions in a well or a group of Wells in the reservoir. Performance data of these objects are then processed in the computer to determine simulated production results. The simulated production results are then compared with the established set of production rules. If any of these rules is violated corrective action for that object for which the rule was violated may be taken.

Therefore, what is needed is a method and system for improving well productivity that do not present (or at least minimize) the above-mentioned drawbacks of each respective prior art.

### SUMMARY OF THE INVENTION

The invention is a system, method and apparatus for stimulating wells of natural resources such as oil gas and water and managing the stimulation process of one or more wells in order to optimize the exploitation of the natural resource from a reservoir.

The invention provides a system that allows a well (or reservoir) manager to collect and process information, devise an approach to manage one or more wells in a production reservoir, and implement methods and systems that increase reservoir production. For example, using the system a manager is able to analyze data collected from seismic probes, identify and anticipate high productivity zones in a reservoir and make decisions for managing production wells in order to optimize production.

The invention provides a modular apparatus that may be configured with one or more modules for providing high-power elastic wave generators, a power source and one or more systems for collecting information and transmitting information data of a wellbottom to a surface data processing and control system. The elastic wave generators comprise devices capable of generating high-frequency elastic waves and devices capable of generating low-frequency elastic waves. The apparatus is able to be fitted with other existing treatment technologies for enhancing recovery. Furthermore, the apparatus does not require to be removed between treatments and may be permanently installed in a well while production is ongoing in order to continuously (or periodically) apply stimulation and collect real-time stimulation and production information.

In an embodiment of the invention, high-energy short duration pulse discharges are performed in a controlled environment inside a radiating chamber in order to generate seismic type waves that are transmitted to a chamber's surface and into the geologic formation.

By combining one or several acoustic modules, the system embodying the invention may be adapted to treat any type of well, depending on a set of parameters that characterize each particular well and/or geologic formation. In embodiments of the invention, one or more modules may be combined to achieve well stimulation. Using a low frequency and high power electro-acoustic module, low attenuation of low frequency mechanical waves allows the waves to travel large distances. This configuration may be intended for long-range applications in reservoirs. The latter device configuration allows for reservoir acoustic treatment at extreme depths (5000 to 15000 meters), and also at shallow depths.

An implementation of the invention may utilize other means to generate low-frequency elastic waves. Low-frequency elastic waves may result from the modulation of high-frequency elastic waves. For example, by periodically operating a high-frequency elastic wave generator in bursts of energy at high-frequency, it is possible to generate low-frequency waves whose wavelength is determined by the low-frequency periodicity of the operation of the device. The latter is owed to the intrinsic properties of the material (e.g., geologic formation) in which the waves propagate.

In addition to the long-range stimulation benefits of low-frequency vibrations, the low-frequency module may be involved in applications that map underground geologic structures using seismic detection technology.

High frequency and high power electro-acoustic modules may be used in short-range applications, such as oil well stimulation. Such modules may affect the oil present in the wellbottom, wellbore and/or perforated zone of the well increasing its fluidity, reducing its viscosity and greatly increasing the well's permeability. Hence enhancing the hydrocarbons extraction rate.

Seismic modules based on a continuous working seismic device may be directed to reservoir characterization in terms of fluid mobility, fluid saturation, and rock effective permeability.

In addition, one or more actuating systems, such as for applying heat treatment, acidizing treatment or any other existing means for treating wells, may be used for applying conventional well treatment either alone or on combination with acoustic wave treatment.

A sensing system that comprises one or more sensors for collecting information about the state of the well may be used to assess the state of each well independently, integrate the data with previously acquired data, and analyze the data within the framework of the reservoir as a whole.

The target applications in accordance with embodiments of the invention comprise integrated reservoir management system, for example, through the installation and operation of one or more of the different modules of the invention in one or more wells in a reservoir; hydrocarbons recovery enhancement at any depth, including extremely deep extraction zones; management system for reservoirs, including the extremely complex reservoirs, and non-conventional deposits; collection and management of new valuable information enabling a manager to decide about operational tasks, e.g., whether or not it is feasible to intervene in the well's operation by means of hydraulic fracturing, acidizing, among others approaches possible.

By combining a versatile tool that allow a reservoir (or well) manager to apply a plurality of treatments to any well in a production field, with the ability to measure in real-time the response of wells to treatment, and integrate newly acquired data with previously acquired data, a system enables a reservoir manager to perform tasks that would either be unfeasible or requires a costly and exhaustive use of several different systems which still comes short of providing real-time data acquisition.

The following are some example of novel uses that are enabled by a system embodying the invention:

If production levels in a well (e.g., pressure and other important parameters) start decreasing in one well, and from seismic data recovered with the system the reservoir manager may determine that the oil in the formation is moving away from such well. A decision may be made to close stop pumping oil from that specific well and turn it into an injection well.

If production of a well begins to decrease, and the pressure on the wells also starts decreasing, it could mean the well is plugged. Based on the analysis of the collected data, the reservoir manager may determine that high frequency radiation is necessary in order to clean the well's production zone. Once the data recovered from the well and reservoir indicates that the production levels have reached a desired (or expected) level again, the high frequency might be stopped, and low frequency radiation applied in order to increase oil's mobility in the reservoir

If production from a well decreases to very low levels and data analysis (e.g., of seismic mapping) indicate the well area is capable of producing, it may indicate that other enhanced oil recovery (EOR) treatments are warranted in addition to the elastic waves treatment. The reservoir manager may determine that secondary and tertiary extraction methods and EOR (enhanced oil recovery) methods might be needed. The efficiency of existing EOR methods is augmented significantly when complemented with other techniques available with this system. For example, acidizing alone reaches a depth of a coupe of one or two inches. When acidizing is complemented with high frequency radiation, acidizing may reach further depths into the reservoir.

If production of a well tends to change over time, by for example, increasing (or alternatively decreasing) following a given treatment, the ability to log all the acquired information and analyze historic data enables a reservoir manager to determine a stimulation-response pattern. Over time, the manager is capable of fine-tuning the pattern of the type, amount and periods of treatments that maximize production of a the well/reservoir.

### BRIEF DESCRIPTION OF THE DRAWINGS

FIG. 1 is a schematic representation of a production oil field having a plurality of wells, where production is managed through the use of an embodiment of the invention.

FIG. 2 shows a schematic representation of a typical well for extracting oil and/or gas, aiming at presenting the context in which a tool embodying the invention is utilized.

FIG. 3 is a block diagram representing components of a system embodying the invention for stimulating a reservoir, managing production, collecting real-time information and processing data for online adjustment of production parameters.

FIG. 4 is a block diagram representing components (or modules) of a tool for stimulating wells in accordance with an embodiment of the invention.

FIG. 5 schematically depicts parts of a low-frequency mechanical wave generator in accordance with an embodiment of the invention.

FIG. 6A schematically illustrate a mode for assembling a tool for stimulating and probing a well in accordance with one embodiment of the invention where a low-frequency module and the power supplier are connected proximally to the tubing and a set of high-frequency acoustic wave generators and actuators are connected distally from the tubing.

FIG. 6B schematically illustrate a mode for assembling a tool for stimulating and probing a well in accordance with one embodiment of the invention where a low-frequency module and the power supplier are connected in between a proximal and a distal segment where each of the proximal and distal segments comprises at least one high-frequency acoustic wave generator and/or at least one actuator.

FIG. 6C schematically illustrate a mode for assembling a tool for stimulating and probing a well in accordance with one embodiment of the invention where a low-frequency module and the power supplier are connected distally to the tubing and a set of high-frequency acoustic wave generators and actuators are connected proximally to the tubing.

FIG. 7 is a block diagram representing components for stimulating wells in accordance with an embodiment of the invention.

FIG. 8 is a flowchart diagram showing steps for stimulating a well using an embodiment of the invention.

FIG. 9 is a flowchart diagram of method steps for managing a production reservoir in accordance with an embodiment of the invention.

### DETAILED DESCRIPTION OF THE INVENTION

The invention provides a system, method and apparatus for stimulating and managing production of a natural resource, such as oil, gas or water, by installing a device in one or more wells within a reservoir, collecting data in real time and applying one or more treatments to the reservoir. The invention provides a tool of the downhole type that can host one or more acoustic stimulation devices, power devices, sensing systems and other actuators that enable the system to apply other treatments in addition to the acoustic treatments. The system is capable of collecting data in real-time, transmitting the data to a data processing center, and processing the data while integrating the real-time data with previously acquired data.

In the following description, numerous specific details are set forth to provide a more thorough description of the invention. It will be apparent, however, to one skilled in the pertinent art, that the invention may be practiced without these specific details. In other instances, well known features have not been described in detail so as not to obscure the invention. The claims following this description are what define the metes and bounds of the invention.

The reference to “natural resource” in the following description may mean any type of product that may be extracted from a geological formation. Throughout the application, the term “Oil” is used to mean crude oil, natural gas, water or any other substance present in a geological formation whose extraction may benefit from an embodiment of the invention. In some specific examples, the term “oil” is used in its usual meaning, such as when describing a situation of an oil well with high content of natural gas, or containing water.

In the following description, the term user may be used to refer to a person using the system, such as an operator of a device, a production manager of an oil field or any other person involved in operating, controlling, communicating with and/or programming one or more components of the system. The term user may also refer to a machine that may be programmed by an operator to operate, control and/or communicate with any portion of the system. In the latter case, a computer that is programmed to capture data, process data and modify the production parameters may be referred as a user.

Existing technologies provide numerous systems for data acquisition, data transmission and data analysis. The data acquisition, data analysis and data transmission used in embodiments of the invention may utilize the existing computer software to carry out any data processing tasks. Alternatively one may develop software based on specific application for using an embodiment of the invention. One with ordinary skill in the art would recognize the specific tools for data processing and/or a digital computer programming required to implement the computer programs involved in implementing the invention without a detailed description of such programs in the present disclosure. The development of such computer programs maybe carried out in a multitude of applications to implement the invention without departing from the scope of the invention.

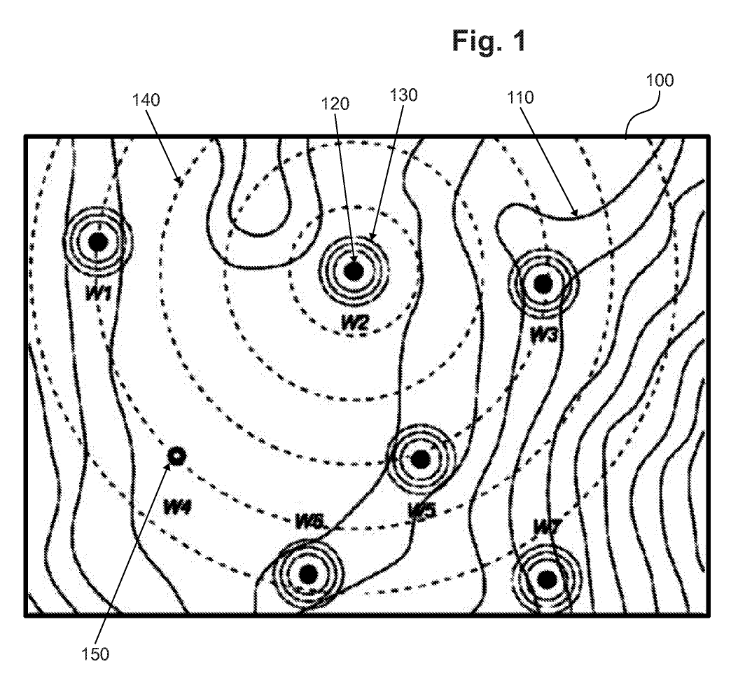

FIG. 1 is a schematic representation of a production oil field having a plurality of wells, where production is managed through the use of an embodiment of the invention. A typical oil field (e.g., 100) hosts a plurality of wells (e.g., W1, W2, W3, W4, W5, W6 and W7). The oil field map 100 shows isopach lines (e.g., 110) that represent regions of equal thickness of a geological layer, which may be the layer that contains the natural resource of interest or any other layer above or below the layer of interest. The latter data are obtained, for instance, from seismic studies in preliminary assessments of the reservoir's content.

A system embodying the invention comprises a plurality of stimulation and/or data collection tools that may be installed in any number of wells in a production field according to the invention. A stimulation device according to the invention comprises one or more devices for generating low-frequency and a high-frequency acoustic waves. In the example illustrated in FIG. 1, a stimulation device is installed in each of wells W1, W2, W3, W4, W5, W6 and W7. The system allows a reservoir manager to operate the stimulation tools in any chosen regime. In the example of FIG. 1, the stimulation tool is operating the high-frequency and the low frequency devices in well 120 (shown as W2), while wells W1, W3, W4, W5, W6 and W7 are operating only the high-frequency device(s). Thus, well 120 generates low-frequency waves (e.g., 140) that are characterized by a large wavelength, and a longer spacial reach, while the high-frequency vibrations (e.g., 130) have a much shorter wavelength and therefore a smaller reach.

A system embodying the invention enables a reservoir manager to collect data in real-time, monitor the production, and vary the parameters of production in order to optimize production. For example, the manager may determine that stimulation treatment should be applied continuously or periodically. Or, the manager may determine the amount and type of treatment. For example, a manager may determine that well 150 should be used as an injection well, if well 150 has a low productivity and the flow of oil Is determined to be moving away from well 150.

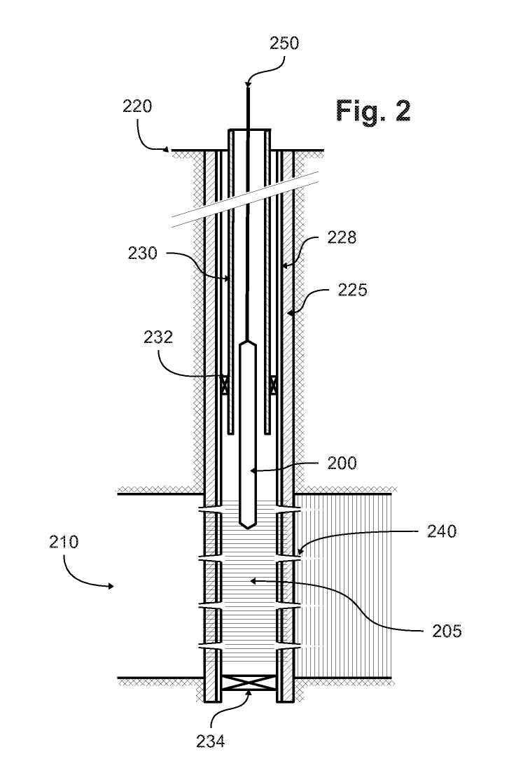

FIG. 2 shows a schematic representation of a typical well for extracting oil and/or gas, aiming at presenting the context in which a tool embodying the invention is utilized. Well 220, for extracting fluids from a geological formation, is basically a hole lined with a cement layer 225 and a casing 228 that houses and supports a production tube string 230 coaxially installed in its interior. The well is connected to a reservoir 210 that has an adequate permeability to let fluids produced in the formation flow through perforations and/or holes 240 in the well lining, supplying a path or trajectory inside the formation.

Typically, there are numerous perforations (e.g., 240) that extend radially from the lined or coated well. Perforations are uniformly separated in the lining, and pass to the outside of the lining through the formation. In an ideal case, perforations are only located within the formation, and their number depends on the formation thickness. It is rather common to have nine (9), and up to twelve (12) perforations per depth meter of formation. Other perforations extend longitudinally, and yet other perforations may extend radially from a 0°-azimuth, while additional perforations, located every 90° may define four sets of perforations around azimuth. Formation fluids pass through these perforations and come into the lined (or coated) well.

Preferably, the oil well is plugged by a sealing mechanism, such as a shutter element (e.g., 232), and/or with a bridge-type plug, located below the level of perforations (e.g., 234). The shutter element 232 may be connected to a production tube, and defines a compartment 205. The production fluid, coming from the formation or reservoir, enters the compartment and fills the compartment until it reaches a fluid level. Accumulated oil, for example, flows from the formation and can be accompanied by variable quantities of natural gas. Hence, the lined compartment 105 may contain oil, some water, natural gas, and solid residues, with normally, sand sewing at the bottom of the compartment.

A tool 200 for stimulating the well in accordance with embodiments of the invention, may be lowered into the well to reach the level of the formation, or in other instances it may be beneficial to stimulate the depths above or below the layer of production. To achieve the latter result, a system embodying the invention provide the capability to operate the tool at any chosen depth. The tool may be connected to the ground surface through an attachment means 250, it may also be attached to the extremity of the tube 230 using an adapter, or it may be mounted in series with segments of the tubing. When mounted in series with the tubing, one or more tools may be installed in each well by simply attaching the tool with a coupling to the tubing, then attaching another tool or a segment of tubing, then repeating the process as many times as desired for any specific application.

Thus, a tool 200 may be lowered momentarily into a well for well treatment or by attaching the tool to the end of the tube 230, the tool may be operated even as the production continues from the well. The attachment means comprise a set of cables for providing the strength for holding the weight of tool 200. The attachment means may also comprise power cables for transmitting electrical energy to the tool, and communication cables such as copper wires and/or fiber optics for providing a means of transmitting data between control computers on the ground and the tool.

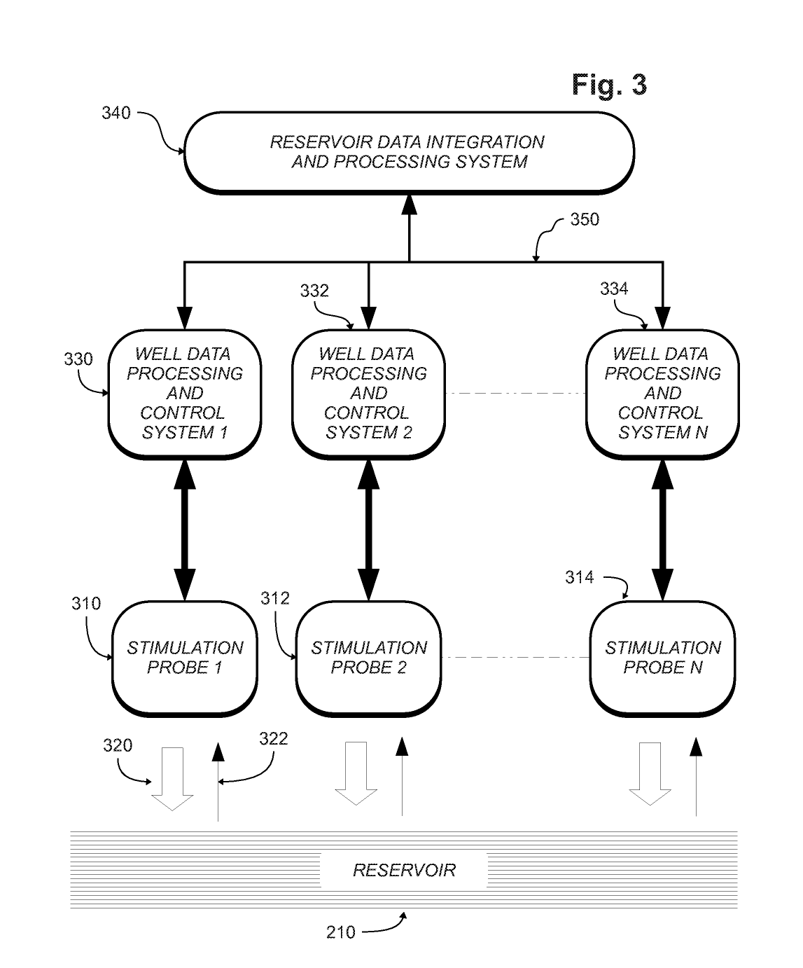

FIG. 3 is a block diagram representing components of a system embodying the invention for stimulating a reservoir, managing production, collecting real-time information and processing data for online adjustment of production parameters. A reservoir 210 is typically equipped with one or more tools (e.g. 310, 312 and 314), also referred as a stimulation probes, for stimulating a reservoir and collecting data.

A Stimulation probe (see below for more details), comprises any combination of the following: one or more low-frequency acoustic wave generating device, one or more high-frequency acoustic wave device, one or more power supplier, one or more actuators for applying other conventional methods of stimulating wells, one or more sensors for collecting data about the operating state of the devices, the physical state of the area surrounding the well, the natural resource movement within any portion of the reservoir (e.g., using seismic sensing).

The stimulation probes (e.g., 310, 312 and 314) applies acoustic energy to the formation though the transmission of pressure waves (e.g., 310) to the rock formation. A stimulation probe, in accordance with embodiments of the invention, comprises one or more sensors for collection formation state information (e.g., 322).

Each stimulation probe is connected to a well data processing and control system (e.g., 330, 332 and 334). A stimulation probe may transmit information collected by the sensors to the data processing and control system through a data transmission means, such copper wires and/or fiber optics, and receive control data, for example, to adjust the power and timing of the application of acoustic wave treatment and/or other conventional treatments, such as heat.

Well data processing and control system (e.g., 330, 332 and 334) comprises a computer system that may individually serve a well or be shared among a plurality of wells belonging to the same reservoir. In addition, the well data processing and control system may be located on-site or off-site.

A system embodying the invention comprises a reservoir data integration and processing system 340. The data integration and processing system allows a reservoir manager to collect the data from a plurality of wells within a production filed, integrate the newly acquired data with previously acquired data and analyze the data. The reservoir data processing and processing system may be located on-site on the production field or may be located remotely. The data is then transmitted remotely though any available networking means 350 (e.g., wired or wireless communication means) for communicating information between well data processing and control systems and reservoir data integration and processing system.

In other implementations of the invention, a reservoir data integration and processing system may host the capabilities of the well data processing the control systems.

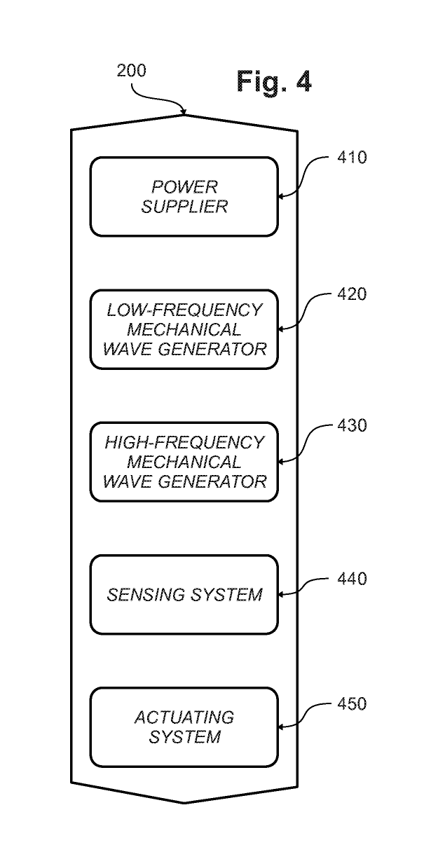

FIG. 4 is a block diagram representing components (or modules) of a tool for stimulating wells in accordance with an embodiment of the invention. A tool 200 embodying the invention may comprise any combination of a power supplier 410, one or more low-frequency wave generators 420, a high-frequency wave generator 230, a sensing system 440 and one or more actuating systems 450. Physically, the latter modules may be mounted in any sequence with the stimulation probe apparatus.

Any of the above listed modules may be constructed using a corrosion-resistant metallic tube as an outer shell within which one or more devices are mounted. Furthermore, one or both ends of the cylindrical tube may be configured to couple with other like-wise configured tubes in order to allow for coupling more devices.

The invention provides a manager with the flexibility to adapt the tool to specific needs for stimulating a well. A tool 200 may combine any number of modules. The type, number and configuration of the modules depend on the goal a well manager may desire to achieve through the stimulation of the well. For example, a tool 200 allows a well manager, after studying the composition of the formation, the flow rate of the liquid, pressure, temperature and any other parameter of the well, to configure tool 200 for a target purpose. The target purpose may be to induce vibration in the rock at a greater distance (e.g., several meters from the well), in which case the manager may choose to use one or more low-frequency wave generators. In other instances, the manager may choose to add multiple high-frequency wave generators, as would be the case for example when more fluidity of oil is desired.

Power supplier 410 is comprised of an electric system capable of receiving power (e.g., direct-current power) from the ground surface through a power transfer cable, transforming the electric power in accordance with the requirement of the other components (e.g., 420, 430, 440 and 450) of tool 200, and delivering power to each component as required. In transforming power, power supplier 410 may convert direct current (DC) to alternative current or vice versa (AC); generate AC currents at one or several frequencies; generate pulsed currents or any type of electric power regime that may be necessary for the proper functioning of a component. To the latter end, power supplier 410 comprises one or more electronic circuits to provide the correct electric current to components 420, 430, 440 and 450 in the tool. For example, tool 200 may comprise an electronic circuit for storing energy in a capacitor and delivering a high-voltage pulse when the energy stored in the capacitor reaches a predetermined threshold. The latter is useful, for example, for driving a low-frequency wave generator that utilizes a high-voltage current to generate an electric arc within a radiating chamber, thus, generating elastic waves.

Power supplier 410 may also comprise electronic circuits enabling it to receive information and execute commands from a computer and/or another electronic circuit. For example, power supplier 410 may receive an instruction from a ground computer to start, stop or resume the operation of any component. It may receive instructions to deliver more or less power to any of the components or change the frequency of operation of one or more wave generators.

Embodiments of the invention comprise one or more low-frequency wave generators 420. Low-frequency sound waves are characterized by their ability to transfer energy over long distances (e.g., hundreds of meters). Embodiments of the invention may utilize any available device capable of generating elastic waves of low frequency of between 0.1 to 1000 Hz, which may result in wavelengths of between 1 meter and 3000 meters.

In addition to being capable of incorporating any available technology for making a module that generates low-frequency elastic waves, the invention provides at least two more ways of generating low-frequency waves, and contemplates using other devices based on different principals. Embodiments of the invention may utilize the periodic delivery of bursts of high-frequency and take advantage of the propagation properties of the elastic waves in the geologic formation, in order to transform the low-frequency periodicity of the application of the high-frequency into low-frequency waves that propagate through the reservoir. The latter low-frequency implementation is fully described in a co-pending US utility patent application (Ser. No. 12/954,906), which is included herewith in its entirety by reference.

Alternatively, embodiments of the invention may implement a low-frequency wave generator that is based on the principal of creating an electric arc, which may be configured to emit powerful sound waves. A detailed description of a low-frequency mechanical wave generator in accordance with the invention is given further below in the disclosure and in a co-pending U.S. patent application Ser. No. 12/962,436, which is included herewith in its entirety by reference.

Moreover, the invention contemplates using the ability of generating a low-frequency elastic wave by striking two (2) hard material at a high-velocity against each other, thus releasing a portion of the kinetic energy as pressure waves. The latter may be implemented on the principal of a hammer and anvil. A hammer may be operated by a driver (e.g., electromagnet) that is able to move at a high-velocity and strike a hard surface target, thus releasing energy in the form of low-frequency elastic waves.

Embodiments of the invention may comprise one or more high-frequency wave generator (e.g., 430). High frequency elastic waves may be produce by any high frequency radiating device (e.g. magnetostrictive transducers, piezoelectric transducers or any other available high-frequency electro-acoustic wave generator). A thorough review of high-frequency techniques for stimulating oil wells is provided in a paper by Wong et al. published by Society of Petroleum Engineers (SPE Production & Facilities, November 2004, Vol. 19 No. 4, Pages 183-188) which is included herewith by reference.

One important effect of high frequency mechanical waves in an oil well is the fluid-to-solid decoupling due to the incapability of viscous forces to compensate for inertial forces throughout the entire volume. The fluid layer closer to the solid is tightly bonded to the solid, oscillating with it, and where the layer thickness decreases as frequency increases. Within the layer, the apparent viscosity increases, whereas in the rest of the pore fluid, a reduction of viscosity is noticed.

The fluid found in a formation is a colloidal system, as a solid phase is found in the fluid. This gives rise to a non-Newtonian fluid, which behaves as a solid or may have extremely high viscosity in certain conditions. Formation fluid affects the near-wellbore region by blocking the flow through the pores, and decreasing the permeability of the zone. This process is known as formation damage.

High frequency mechanical waves affect formation damage by two means. The first one is the disintegration due to mechanical oscillations, when the energy is sufficient (10⁻⁷ J/cm³), which destroys long-spaced coagulation structures. The second means is electro-osmosis, from the oscillation of a solid immersed in a fluid that generates non-compensated electrical charges. This can lead to a breakage of van der Waals bonds between the particles.

A tool embodying the invention (e.g., 200) may comprise a sensing system 440. A sensing system comprises one or more sensors designed to capture physical parameters such as temperature, pressure, gas content and any other physical manifestation relevant to oil recovery and well management. Sensors are chosen for the task based on their industrial design to withstand the stress of the elements in the operating environment. For example, sensors must be designed to withstand the corrosive environment under which operations are conducted.

Moreover, sensors may include seismic sensors capable of detecting waves propagated through the rock formation. The latter sensors may be very valuable for collecting seismic data during operation of the stimulation device and production. A system implementing the invention is thus capable of conducting real-time surveying of the reservoir, since the system comprises both the low-frequency seismic type wave generators that are installed in a plurality of wells, and the sensors to detect the propagation properties of the waves. Thus, a system implementing the invention is capable of providing detailed seismic mapping of a reservoir at any time of operation by collecting the data from the seismic sensors and processing the data.

A sensing system 440 in accordance with implementations of the invention, may comprise a set of transducers for converting physical information into digital information for transmission to a remote computer.

Tool 200 embodying the invention may comprise an actuating system 450. The actuating system 450 comprises any combination of available tools (or actuators) such as heaters, high-pressure water nozzles and any other tool available for well treatment. A tool assembled in accordance with the teachings of the invention, may utilize a coupling in order to attach one or more actuators in series with other components of the tool.

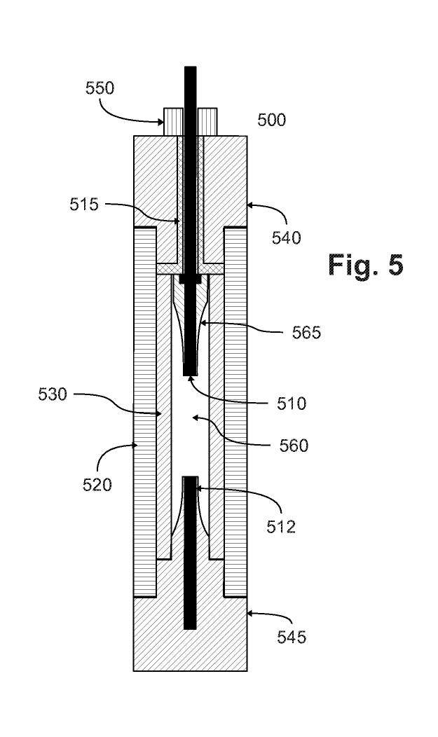

FIG. 5 schematically depicts parts of a low-frequency mechanical wave generator in accordance with an embodiment of the invention. The low-frequency mechanical wave generator of FIG. 4 comprises a radiation chamber 560 where high energy short duration pulse discharges are performed in a controlled environment inside the chamber.

The low-frequency mechanical wave generator 500 may be constructed using an outside casing 520, two or more lids (e.g., 540 and 545), a first and a second electrodes 510 and 512, respectively, a rubber interior coating 530, insulating sleeves 515 (e.g., Teflon sleeves) and rubber flanges (e.g., 550). The chamber 560 within which the electrodes protrude may be filled with a fluid. In some application the fluid in chamber 560 may be more or less electrically conducting depending on the desired application.

Casing 520 may be constructed using a corrosion-resistant metal or any other material that provides necessary strength, resistance to corrosion and other physical properties such as electric and heat conductance, density or any other property that would be relevant for any given application. It is noteworthy that the casing's material's physical properties are relevant because the shape and size of the casing may determine relevant vibration properties of the tool. For example, low-frequency mechanical waves generator may be designed to have a given desired resonance frequency.

The low-frequency mechanical waves generator 500 comprises an energy storage device that is charged by means of a power source. When the required energy levels for breaking the electric breakdown voltage of the non-conductive fluid inside the radiation chamber 560 are reached, all the energy is pulse-discharged from the energy storage device into the fluid. The latter results in an explosion inside chamber 560, creating shock waves.

In embodiments of the invention, the interior of chamber 560 may be carved to provide one or more surfaces that reflect pressure waves in such manner that the waves can be focused and/or propagated in a specific direction. For example, shape feature 565 may be a parabolic surface the reflection of which would transform a spherical pressure wave emanating from the inter-electrode space into a radial pressure wave that propagates perpendicularly to the axis of tool 500.

Low-frequency mechanical waves are generated due to the excitation regime of the pulse discharges of the energy storage system. A system embodying the invention comprises a radiating chamber the length of which may be half the wave length (λ/2, where “A” symbolizes the wave length) or an integer multiple of the wavelength of the electro-acoustic vibration. The wavelength depends on the speed of pressure wave in the material chosen for the construction of the chamber. For example, using stainless steal which has an approximate conductivity of sound waves of 5000-6000 m/s, the chamber would possess a wavelength of between 2.5 m and 12.5 cm for a resonance frequency of 1 kHz to 20 kHz.

In embodiments of the invention, in order to increase transmission of the electro-acoustic power, chamber 560 may be filled with a conductive fluid (e.g., calcium chloride dissolved in water). Electrodes may also be positioned at a specific distance to break the electrical breakdown voltage of the liquid. An electric discharge regimen may be established for the low frequency radiation (e.g. for low frequency oil/gas or water reservoir stimulation 1 Hz to 200 Hz is recommended). Said regimen is achieved by means of charging and discharging the energy storage device (e.g., using a high voltage low impedance capacitor).

An embodiment of the invention provides a corrosion-resistant heatsink chamber capable of being used as an acoustic resonance chamber. The disposition of the chamber in relation to other wave generators attributes to the device its resonance characteristics. The corrosion-resistant heatsink chamber also prevents the system from overheating by means of a heatsink liquid which fills the device, allowing the system to work in gas reservoirs or oil wells with high concentration of gas. When working in heavy oil wells, the capacity to efficiently transfer the heat generated by the wave radiators to the environment also improves the capacity of the system to reduce the viscosity of the crude, thus facilitating crude oil extraction.

In a device embodying the invention comprising a low-frequency electro-acoustic radiating module, the chamber may be made of corrosion-resistant rubber 530 (e.g. rubber wrapped in Teflon) the length of which may be λ/2 or an integer multiple of λ, which is the wavelength.

An embodiment according to FIG. 5, where the material inside the corrosion-resistant radiating chamber is a non conductive material (e.g. air). The energy needed in the energy storage device must reach the necessary levels for achieving the electric breakdown voltage in the gap between the electrodes. When such levels are reached, a pulse discharge of the energy stored in the energy storage device will be performed in the gap between the electrodes creating the shock wave of the elastic wave.

In embodiments of the invention the device comprises an adapter (not shown) that connects the low-frequency wave generator to the well's casing. In the latter embodiment low frequency is radiated to the reservoir through the natural resonance frequency of the well's casing. For instance, the natural resonance frequency of steel casing of a 2.5 km well is 1 Hz, considering a sound speed of 5000 m/s in steel from which said casing is typically made. As an added benefit, a device embodying the invention may be used in abandoned wells (within a reservoir) that may be dedicated to stimulating the reservoir with high-power, high- and low-frequencies, without concern for damage to the cement walls of those wells.

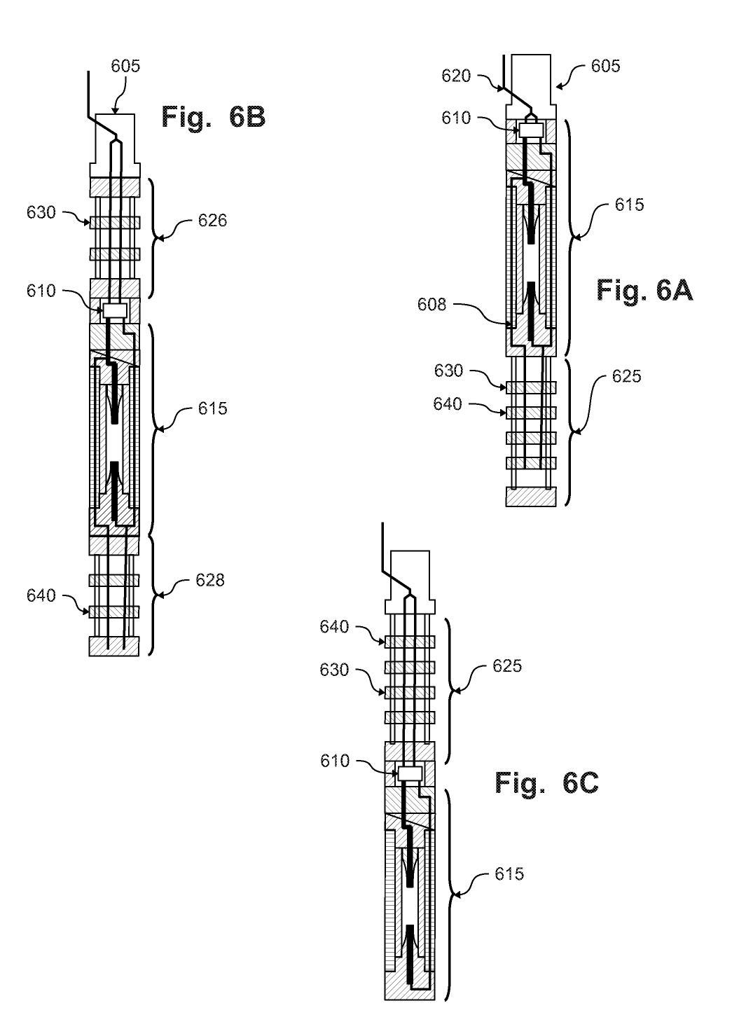

FIG. 6A schematically illustrate a mode for assembling a tool for stimulating and probing a well in accordance with one embodiment of the invention where a low-frequency module and the power supplier are connected proximally to the tubing and a set of high-frequency acoustic wave generators and actuators are connected distally from the tubing. In the illustration of FIG. 6A, a power supplier segment 610 is attached to a coupling 605 that connects the tool with the well's tubing. The next component of the tool, in the latter example, is a low-frequency acoustic wave generator 615. Other segments, such as 625, may be attached to the end of the low-frequency generator. The segment 625 comprises any number of high-frequency acoustic 630 wave generators and/or actuators 640. A cable system 620 comprises the wires for carrying power to the power supplier 610 and/or to the high-frequency acoustic wave generators and actuators. The cables may also comprise wires for transmitting data between the tool and the data processing and control systems.

FIG. 6B schematically illustrate a mode for assembling a tool for stimulating and probing a well in accordance with one embodiment of the invention where a low-frequency module and the power supplier are connected in between a proximal and a distal segment where each of the proximal and distal segments comprises at least one high-frequency acoustic wave generator and/or at least one actuator. FIG. 6B shows two segments 626 and 628 of the tool in addition to the low-frequency segment 615. In the latter example, each of the segments connected proximally and distally, respectively, may host at least one high-frequency acoustic wave generator and at least one actuator.

FIG. 6C schematically illustrate a mode for assembling a tool for stimulating and probing a well in accordance with one embodiment of the invention where a low-frequency module and the power supplier are connected distally to the tubing and a set of high-frequency acoustic wave generators and actuators are connected proximally to the tubing.

The device for generating low- and high-frequency electro-acoustic waves may be configured such that the low-frequency radiating section may be place above, below or in between the high-frequency radiating elements. Since the device is intended to be modular and flexible, the construction may require to simply attach each low- and high-frequency waves generators (e.g., 640) in a chain-like fashion and supply it with electric power from the power supplier 610. One or more cables (e.g., 608) connect the power supplier to each one of the waves generators.

The modular construction of a device embodying the invention is an important feature compared with prior art. Well managers are enabled to assemble a device for treating a given well based on the specific characteristics of that well. For example, based on information from the geology of the formation, the type of oil extracted from the well, the reserves in the reservoir and any other characteristics of the well, a manager may determine which treatment (e.g., high power high-frequency v.s. low-frequency) could lead to the desired results. Using an embodiment of the invention, a manager may assemble modular components that fulfill the goal.

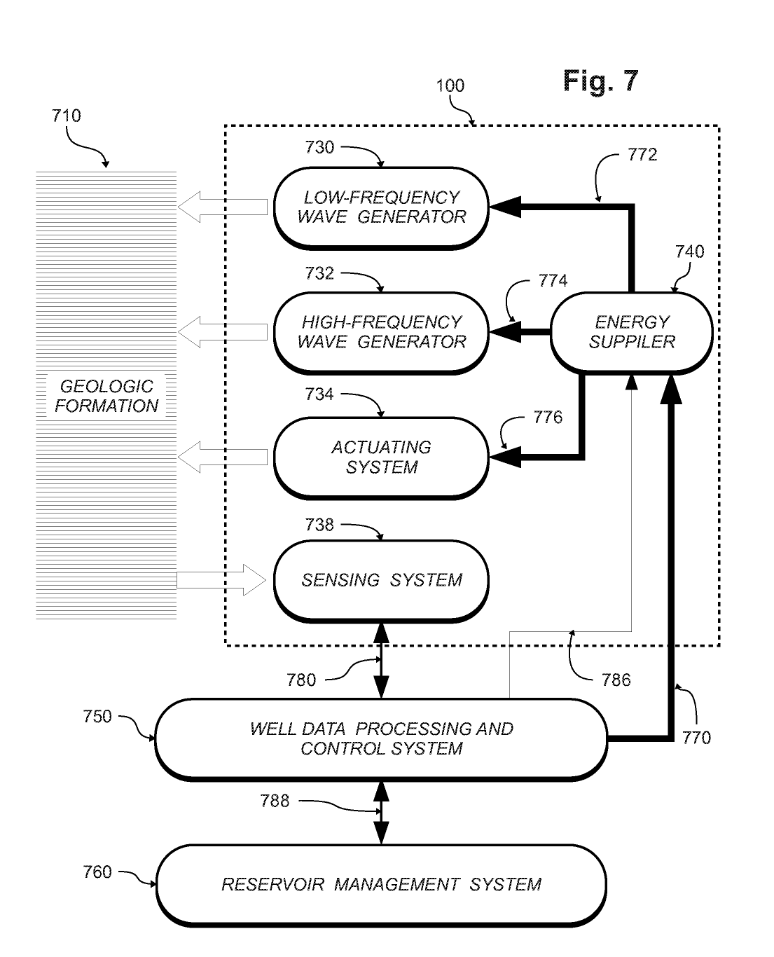

FIG. 7 is a block diagram representing components for stimulating wells in accordance with an embodiment of the invention. The most important factor in recovering a natural resource, such as oil, gas or water, is the geologic formation 710 in which the natural resource resides. The content in minerals, texture compaction are among the physical factors that characterize the geologic formation. When stimulating a well, one has to also take into account the characteristics of the resource itself. For example, oil may greatly differ in its chemical composition and gas content from one well to another within the same reservoir, even as the geologic formation remains similar. The latter is taken into account when selecting the methods by which a well should be stimulated.

Embodiments of the invention provide a tool (e.g., 200) that may comprise one or more components for applying several different stimulation regimens using mechanical waves, applying one of more treatments such as high-pressure water blasting, and collecting information from the well in order to assess the result of the stimulation and re-adjust the treatment parameters.

FIG. 7 is a block diagram representing components of a system for managing a well through acoustic stimulation in accordance with an embodiment of the invention. As described above, the system comprises a tool (e.g., 200) of a downhole type. The tool comprises a plurality of devices comprising one or more high- and low-frequency acoustic wave generators (e.g., 732 and 730, respectively), one or more power generators 740, one or more actuating devices 734 and one or more sensing devices 738. In addition, a system embodying the invention comprises a data processing and control system 750. The data processing and control system is comprised of a one or more computers. A computer (e.g., of the personal computer type or server) may be any computing device equipped with a processor, memory, data storage system, capable of executing software instructions. The computer is enabled with electronic interfaces for communication with other computers and other devices such as analog and digital networking switches, telephones lines, wireless communication, and any other device capable of receiving, processing and/or transmitting data.

The data processing and control system 750 provides a user interface that allows a manager to interact with data processing and control. During operation, the acoustic treatment of a well results in changes that affect the geologic formation 710. The latter changes may be reflected in one or more physical parameters such as temperature, pressure, acidity of the water, flow rate of natural resource, gas content or any other parameter that may be measured with a sensor placed in the sensing system. Other types of information are not directly reflected in the measured parameters, but through data processing a manager may be enabled with the expertise to interpret the result of the data processing and make decision for further treatments accordingly. For example, after collecting the data over a period of time, the manager may learn from the data processing that a given trend is taking place, upon which, the manager may make a decision to take steps to stimulate the well to improve the recovery and/or anticipate future problems that may slow or disrupt production.

The data processing and control system may provide the energy necessary to supply the energy supplier 740. A power cable (e.g., 770) is typically lowered into the well along with the downhole tool. The control system may deliver the power, for example, in a raw form such as direct-current power or as modulated electrical power that directly controls the downhole device. In the case where the power is delivered to the power supplier, the control system may simply communicate commands to the power supplier. Communication is established through communication means 786 which may be wires, fiber optic cables or other means selected to implement the invention. The commands from the control system to the power supplier may include instructions that determine the driving power the power supplier delivers to any of the devices such as the acoustic wave generators, sensing system and actuating system. For example, the data processing and control system allows a manager to preset the periodicity at which a low-frequency acoustic wave generator should operate.

The power supplier 740 comprises a plurality of electronic circuits each of which may be designed to drive an individual component. For example, power supplier 740 may generate high-voltage pulses that drive (e.g., 772) the low-frequency acoustic wave generators; power supplier 740 may generate a high-frequency power to drive (e.g., 774) high-frequency acoustic wave generators; power supplier 740 may generate the power necessary to drive (e.g., 776) other devices (e.g., heating system) for carrying out one or more treatments to stimulate the well.

The data processing and control system may connect with the sensing system in order to collect data through communication means 780. The sensing system enables embodiments of the invention to collect data in real-time. Since the downhole tool may be attached to the end of the tube (as described above), using embodiments of the invention allows for treating a well while simultaneously collecting data and following the progress of the treatment.

Systems embodying the invention comprise a reservoir management system 760. The reservoir management system is also capable of processing data and providing a user with an interface to interact with data processing and operations. The reservoir management system is comprised of one or more computers that may be located locally (e.g., in the vicinity of the production wells) or remotely at a central facility. The reservoir management system is equipped communication devices such networking switches, wireless communication and any necessary interface to communicate data between computers within the system to and from a remote.

A user, such as a well manager, may integrate a plurality of data processing systems and determine the parameters for acting on a particular well and/or multiple wells simultaneously.

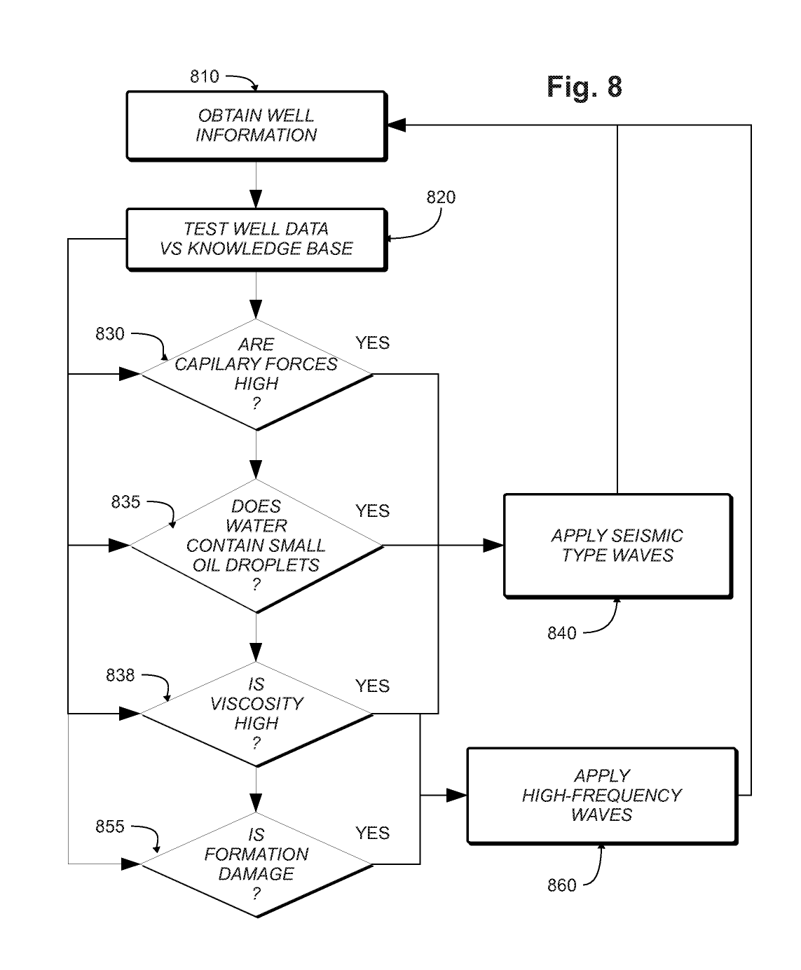

FIG. 8 is a flowchart diagram showing steps for stimulating a well using an embodiment of the invention. The steps of the flowchart of FIG. 8 are for illustration only and do not restrict a user of a system embodying the invention to follow the steps in the order in which they shown in the Figure. A user, such as a well/reservoir manager, may select to investigate any of the parameters of the well production, then make decision based on indicators. The steps and type of well stimulation are then carried out following the results of the tests. The invention provides the flexibility that information from well may be visited at any point in time and a system embodying the invention that is installed in a well may be operated to stimulate the well.

At step 810, a user of a system in accordance with the invention may initially collect a plurality of information about a well and/or a reservoir. For example, seismic studies, rock composition analysis during drilling, chemical analysis of the resource to be (or being) extracted, flow rate of the resource, well pressure and a plurality of input data are all data that help the manager determine whether the well needs treatment and which type of treatment is needed. At step 820, the manager test the collected data against a knowledge base. The latter knowledge base includes information previously collected through other means (e.g., preliminary geology studies of the reservoir), data collected using the sensing system provided by the system embodying the invention, as well as real-time information collected during operations using an embodiment of the invention. The result of such tests provides indicators for the wells state. For example, in an oil well where flow has diminished while viscosity of the recovered oil is unchanged may be an indicator that the pores in the extraction zone have been clogged rather than oil flow was affected by a change in the physical nature of the oil.

One or more steps of testing may be carried out in order to help the manager assess the condition of the well and select one or more methods of treatments to apply to the well. For example, at step 830, a manager may check whether the indicators point to a rise in the capillary forces, which would be an indicator of reduced pore diameter. In the latter case the manager may apply seismic type waves treatment at step 840. Seismic type waves are typically of low-frequency (i.e. large wave-length) waves, which travel very long distances compared to high-frequency (i.e. short wave-length) waves. Seismic type treatment tend to increase pore diameter, thus reducing the capillary forces and so break liquid surface films adsorbed to pore boundaries. Seismic type treatment may also induce increased flow as the Bjerknes forces induce coalescence of oil droplets making them oscillate and move. Seismic type treatment may also in crease temperature.

Generally, in a typical depleted well, residual oil is found dispersed in water in the shape of droplets, due to density separation of these two fluids. Capillary forces play a very important role in the liquid percolation through small pores, where liquid films are adsorbed to the pore walls, making the droplets more difficult to move and reducing the effective pore diameter. Because of this, the required pressure drop for percolation needs to be higher, meaning a lower mobility. Seismic type waves reduce the capillary forces since it destroys the surface films adsorbed in the pore boundaries, reducing its adherence to the surface, increasing the effective cross-section of the pore.

Moreover, mechanical waves with wavelength larger than the oil droplet diameter induce movements of the droplets. Bjerknes forces, which are attracting forces of oscillating droplets of one fluid in another, induce the coalescence of the oil droplets, forming oil streams in the porous space. As a result, oil mobility increases.

A well/reservoir manager may test in an oil well, at step 835, whether the water recovered along with the oil contains small droplets of oil dispersed in the water, which would be an indicator of reduced mobility. If the latter case is true, the manager may select to apply seismic type waves at step 840. At step 838, the manager may test whether the viscosity of the oil is high, which also may indicate that mobility of oil is (or will be reduced). If viscosity of oil is rising, embodiments of the invention allow for both stimulating the well with low-frequency waves, at step 840, and high-frequency waves at step 860, which would stimulate the flow of oil from a distance in the formation into the well, and by applying high-frequency increase the fluidity of the oil.

At step 855, the indicators may point to damage in the formation. In the latter case, the manager may apply, at step 860, high-frequency waves, which help clear debris from the cracks in the formation.

One important effect of high frequency mechanical waves in an oil well is the fluid-to-solid decoupling due to the incapability of viscous forces to compensate for inertial forces throughout the entire volume. The fluid layer closer to the solid is tightly bonded to the solid, oscillating with it, and where the layer thickness decreases as frequency increases. Within the layer, the apparent viscosity increases, whereas in the rest of the pore fluid, a reduction of viscosity is noticed.

The fluid found in a formation is a colloidal system, as a solid phase is found in the fluid. This gives rise to a non-Newtonian fluid, which behaves as a solid or may have extremely high viscosity in certain conditions. Formation fluid affects the near-wellbore region by blocking the flow through the pores, and decreasing the permeability of the zone. This process is known as formation damage.

High frequency mechanical waves affect formation damage by two means. The first one is the disintegration due to mechanical oscillations, when the energy is sufficient (10⁻⁷ J/cm³), which destroys long-spaced coagulation structures. The second means is electro-osmosis, from the oscillation of a solid immersed in a fluid that generates non-compensated electrical charges. This can lead to a breakage of van der Waals bonds between the particles.

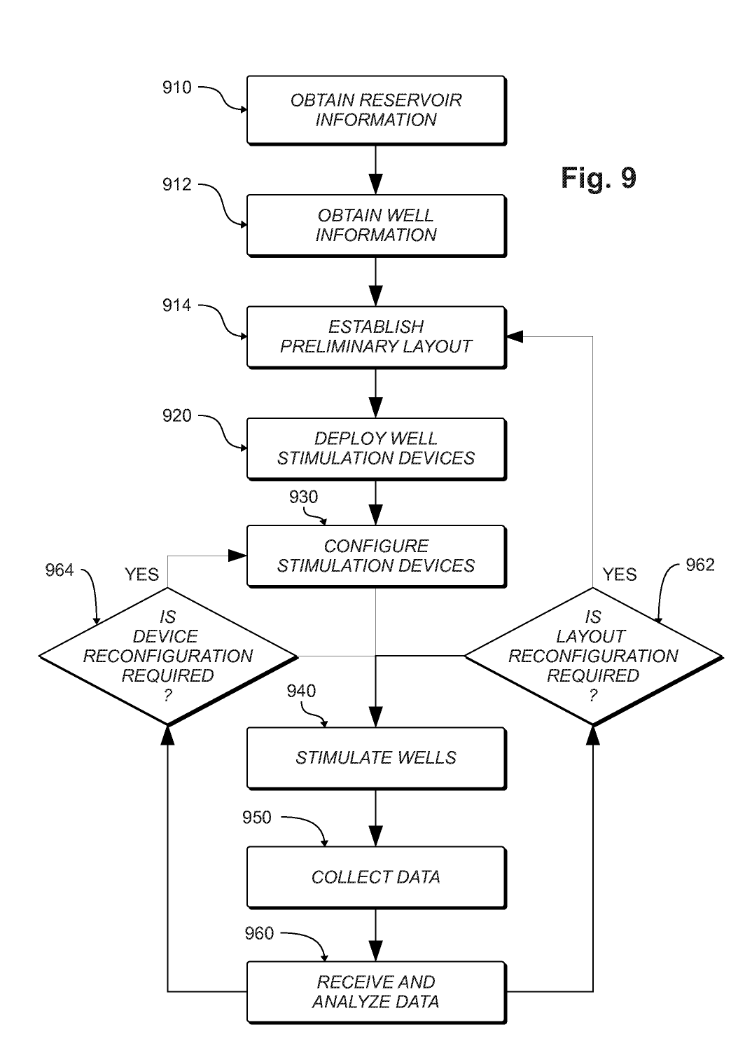

FIG. 9 is a flowchart diagram of method steps for managing a production reservoir in accordance with an embodiment of the invention. Step 910 involves collecting preliminary data, such as geological surveys of the field, geophysical studies results and any other data that may be collected before drilling in a reservoir. Since a system embodying the invention is well fitted for installation in aging oil fields because of diminishing production, many of the data may have been obtained many years before the installation of the system. The system is enabled to integrate information from several types of data. For example, maps that were conducted at the beginning of exploitation may be compared to maps that were obtained at one or more surveys over time. The latter should allow a reservoir manager to extract valuable information about the flow of the resource in the ground and make decision to further use the system to stimulate wells in the reservoir.

Reservoir data may be input into a computer system that stores, processes and allows a manager to run several types of data processing tools, for representation of actual state of the reservoir and/or for simulation and prediction purposes. For example, by comparing previous maps of reservoir's content with periodically obtained reservoir maps, it is possible to obtain a four-dimension mapping of the reservoir i.e. a three-dimensional map of the reservoir over a period of time. Such mapping could reveal, for instance, a movement of the natural resource within a reservoir, or whether some areas of the reservoir are depleted faster than others, or any other information that may be informative to a reservoir manager, or that may be inferred from the data.

Step 912 involves obtaining each well's information. As described above, a log is kept for each well during drilling and throughout production. Well data comprise physical data, such as pressure, temperature, acidity and many other relevant information. Well data also comprise production history, and behavior characteristics. The latter characteristics define the production changes that may have occurred in a well, either spontaneously or as a result of one or more stimulation treatments. Well information is important not only to characterize the well itself, but also to further supplement the characterization of the reservoir as a whole. Well information may be input into a computer system in order to create graphic representations of the state of a well, develop maps (e.g., 3D and 4D) of the reservoir, monitor the changes in well production, and anticipate the changes that may occur as a result of well treatments.

Step 914 involves establishing a preliminary layout for deployment based on the knowledge gathered from the reservoir and wells data in the system. A well manager is enabled to designate, for example, wells to be production wells equipped with a well stimulation tool, and other wells that will serve only for stimulation and data collection but not for production. Consequently, the manager determines at step 914 which type of devices are to be implemented in a stimulation pro and in which specific well. For example, as described above, one well may be equipped with a combination of a high- and a low-frequency acoustic stimulation devices, while another well may be equipped with a downhole tool comprising a different combination of devices in keeping with the assessed requirement for treatment.

Step 920 involves deploying a downhole tool in each chosen well. Deployment involves determining whether the downhole tool is installed permanently or temporarily in the well, the depth at which the treatment is applied and any other factors involved in optimizing the location of the treatment. Step 920, also involves determining the number of devices to be installed within each well. For example, the downhole tool may comprise more that one generator of high- or low-frequency acoustic devices in one well, while in another well, the number of devices may be different.

Deploying downhole tools for well stimulation and data collection of step 920, also involves determining how the downhole tool is lowered into the well and held in place during operation. For example, the downhole tools may be comprised within the tube, mounted in series with other segments of the tubing or it may be attached to the end of the tubing.

Step 930 involves configuring the stimulation devices. As described above, a control module allows for selecting a regime at which a device comprised within the downhole tool operates. The manager of the reservoir may configure the device in each downhole tool to operate at a specific regime, which would optimize production in a reservoir as a whole. For example, the manager is enabled to configure the periodicity at which low-frequency acoustic discharges are applied. The configuration parameters are flexible, and can be changed at any time in the system in accordance with embodiments of the invention. Step 930 may be conducted manually by user intervention, or automatically such as in the case of a continuous monitoring that provides feedback to the system that automatically adjusts the configuration parameters of the downhole devices.

Step 940 involves applying one or more regimes of stimulation to one or more wells. During step 940, the devices in the downhole tools are operated by supplying the power in a modulated form to drive the devices, or in other instances by supplying raw electric power, and the instruction through the command module to generate the modulated power, which drives the high- and/or low frequency acoustic generators.

Step 950 involves collecting data from the sensors that are installed in the downhole tools and other sensors that may be installed on the ground surface. Data collected reflect the type of sensors used for each intended application. For example, each well tool may comprise a number of measurement sensors for capturing temperature, pressure and other physical parameters. Geophones are used to capture seismic-type pressure waves that are reflected off underground surfaces, which helps build 3-dimensional and 4-dimensional underground maps.

Geophones (i.e., seismic sensors) as used in the invention combined with the data processing methods provide a

Step 960 involves receiving and analyzing the collected data in accordance with the teachings of the invention. Collected data captured by the sensors in the downhole and ground surface are transmitted to the data processing modules. The collected data is transmitted to a computer system that integrates newly collected data with previously collected data as well as production data. The system processes the data, and one or more analyses may be conducted. A manager is enabled with data analysis tools and graphical representation tool to apply specific processing steps (e.g., mapping, comparison of maps) to make decisions with regard to the further steps that may be required to optimize production.

Step 962 involves determining, based on the results of data analyses, whether the layout of the downhole tools within a reservoir is warranted. For example, when production has changed in one area of the reservoir, the manager may determine that the downhole tool in one or more wells is to be configured differently or its location changed, such as adding more acoustic generators or changing the depth of deployment. The affected downhole tools are then changed and a new layout is established and the tools deployed.

Step 964 involves determining, based on the results of data analyses, whether the operation regime of one or more downhole tools within a reservoir is to be modified. A manager may change the acoustic frequency, intensity and/or periodicity of the pulses of the acoustic treatment. The latter process may be conducted by issuing instructions through a computer system (e.g., locally or remotely) to a the control modules of each downhole tool.

Thus a system, apparatus and method for stimulating productivity of natural resource production fields is described. The invention provides an apparatus comprising one or more high- and/or low-frequency acoustic wave generating devices, actuators for applying conventional well treatments, and sensors for collecting well information. The system in accordance with the invention provides means to process data, and integrate newly acquired data with previously acquired data. The system allows a reservoir manager to visualize the data, make assessment concerning the requirement of stimulation (or any other treatment type), and configure each stimulation probe according to the assessed needs of each in a filed.

The invention provides the ability to increase production capacity of oil, gas and/or water wells via stimulation of the wellbore for deep and shallow applications, provide seismic tools for seismic survey for deep and shallow applications, and provide an integrated reservoir management system combining well stimulation, reservoir stimulation, seismic surveying, and real-time data collection.

The claimed invention is:

1. A system for managing extraction of a natural resource from a geologic formation, comprising:
means for stimulating at least one well;
means for collecting well data from said at least one well;
means for transmitting said well data to a data processing center;
means for processing well data; and
means for issuing commands to control said means for stimulating said at least one well.

2. The system of claim 1, wherein said means for stimulating further comprising means for generating low-frequency acoustic waves.

3. The system of claim 1, wherein said means for stimulating further comprising means for generating high-frequency acoustic waves.

4. The system of claim 3, wherein said means for generating high-frequency acoustic waves further comprising piezo-electric means for generating said high-frequency acoustic waves.

5. The system of claim 3, wherein said means for generating high-frequency acoustic waves further comprising magneto-sctrictive means for generating said high-frequency acoustic waves.

6. The system of claim 1, wherein said means for stimulating further comprising means for generating low-frequency acoustic waves and means for generating high-frequency acoustic waves.

7. The system of claim 1, wherein said means for collecting data further comprising means for sensing physical parameters of a wellbore.

8. The system of claim 1, wherein said means for processing data further comprising:
means for receiving seismic studies data from at least one source of data; and
means for mapping said well data and said seismic studies data.

9. The system of claim 8, further comprising means for determining the magnitude and direction of fluid movement in a reservoir.

10. A method for managing extraction of a natural resource from a geologic formation, comprising the steps of:
obtaining preliminary data of a reservoir having a plurality of wells;
obtaining well data for each of said plurality of wells;
establishing a preliminary layout for deployment, comprising determining a type of each of a plurality of downhole tools for deploying at least one of said plurality of downhole tools in one well of a subset of wells of said plurality of wells;
deploying said at least one of said plurality of downhole tools in one well of a subset of wells of said plurality of wells;
configuring said plurality of downhole tools; and
applying at least one regime of stimulation to each of said plurality of downhole tools.

11. The method of claim 10, wherein said step of obtaining said preliminary data further comprising obtaining said preliminary data from a plurality of data sources.

12. The method of claim 10, wherein said step of obtaining said well data further comprising comparing maps obtained from a plurality of surveys conducted over time.

13. The method of claim 12, wherein said step of obtaining said well data further comprising obtaining pressure, temperature and acidity data from at least a subset of wells of said reservoir.

14. The method of claim 10 further comprising storing said preliminary data and said well data on a at least computer.

15. The method of claim 14 further comprising graphically representing said preliminary data and said well data on a computer.

16. The method of claim 15 further comprising developing a four-dimension graphical representation of said reservoir.

17. The method of claim 10 further comprising monitoring changes said plurality of wells.

18. The method of claim 10, wherein said step of deploying further comprising permanently deploying said at least one of said plurality of downhole tools in said one well of said subset of wells of said plurality of wells.

19. The method of claim 18, wherein said step of deploying further comprising mounting said at least one of said plurality of downhole tools in series with a tubing of said one well of said subset of wells of said plurality of wells.

20. The method of claim 18, wherein said step of deploying further comprising mounting said at least one of said plurality of downhole tools attached at the end of a tubing of said one well of said subset of wells of said plurality of wells.

21. The method of claim 18, wherein said step of deploying further comprising mounting said at least one of said plurality of downhole tools attached inside a tubing of said one well of said subset of wells of said plurality of wells.

22. The method of claim 10, further comprising the steps of:
collecting real-time data from a set of sensors in at least one of said plurality of said downhole tools;
processing said real-time data;
determining whether a secondary layout of said plurality of said downhole tools requires to be established;
determining whether a subset of said plurality of said downhole tools needs to be modified; and
determining, based on the results of data analyses, whether the operation parameters are to be changed.

23. The method of claim 10, wherein said step of applying said at least one regime of stimulation further comprising operating a first subset of said plurality of downhole tools in a low-frequency regime, and operating a second subset of said plurality of downhole tools in a high-frequency regime.

24. The method of claim 23, wherein said step of applying said at least one regime of stimulation further comprising remotely applying the configuration parameters of said stimulation regime.

25. An Apparatus for stimulating a well that produces any one of oil, gas and water comprising:
means for generating low-frequency mechanical waves;
means for collecting a plurality of information data of a well's production parameters;
means for providing electrical power having at least one electronic circuit for delivering a high-voltage pulse for driving said means for generating low-frequency mechanical waves; and
means for transmitting said plurality of information data to a control unit.

26. The apparatus of claim 25 further comprising means for receiving a plurality of command data from said control unit.

27. The apparatus of claim 25 further comprising means for generating high-frequency mechanical waves.

28. The apparatus of claim 27 further comprising at least one piezoelectric high-frequency transducer.

29. The apparatus of claim 27 further comprising at least one magnetostrictive transducer.

30. The apparatus of claim 25 further comprising means for optimally directing said mechanical waves toward a geologic formation.

31. A method for stimulating a resource-producing well comprising the steps of:
obtaining a plurality of information data for a resource-producing well;
determining a treatment to apply to said resource-producing well; and
applying at least one type of acoustic waves to said resource-producing well.

32. The method of claim 31, wherein said step of obtaining said plurality of information data further comprises collecting real-time information data from at least one sensor embedded within said resource-producing well.

33. The method of claim 31, wherein said step of determining further comprises comparing said plurality of information data to a set of status indicators database.

34. The method of claim 33 further comprises determining the level of the capillary forces in perforation of said resource-producing well.

35. The method of claim 33 further comprises determining whether a water recovered from an oil well contains small droplets of oil.

36. The method of claim 33 further comprises determining the viscosity level of oil from an oil well.

37. The method of claim 33 further comprises determining formation damage.

38. The method of claim 31, wherein said step of applying said at least one type of acoustic waves further comprises generating low-frequency elastic waves.

39. The method of claim 31, wherein said step of applying said at least one type of acoustic waves further comprises generating applying a high-frequency elastic wave.

40. The method of claim 39, further comprises utilizing a magnetostrictive device.

41. The method of claim 39, further comprises utilizing a pietzoelectric device.
